(19) United States
(12) Patent Application Publication
(10) Pub. No.: US 2013/0153587 A1
(43) Pub. Date: Jun. 20, 2013

(54) Storage container for storing a liquid food

(71) Applicant: WIK FAR EAST LTD., North Point (CN)

(72) Inventor: Christoph Speh, Mulheim an der Ruhr (DE)

(73) Assignee: WIK FAR EAST LTD., North Point (CN)

(21) Appl. No.: 13/713,431

(22) Filed: Dec. 13, 2012

(30) Foreign Application Priority Data
Dec. 16, 2011 (DE) 20 2011 052 328.4

(51) Int. Cl. A47J 41/00

(52) U.S. Cl. CPC A47J 41/005
USPC 220/592.15; 220/212.5

(57) ABSTRACT

A storage container is described for storing a liquid food, for example milk, for supplying the same to a drink preparation machine, such as a coffee machine. The container has a closed top with a top serving opening for removing liquid needed for preparation from the container. The container has a pivotable handle connected to it for carrying container. The handle has a closure body for closing the serving opening 11 mounted on it. The handle, due to its pivotability on the container 7 and the closure body location on the handle are disposed such that in the folded-down position of the handle 8 when it is not in use, the serving opening is closed by the closure body.

### CROSS REFERENCE APPLICATIONS

This application claims the benefit of German Application No. 20 2011 052 328.4 filed Dec. 16, 2011, which is incorporated herein by reference for all purposes.

### BACKGROUND

Coffee machines, particularly fully automatic ones, are sometimes used as drink preparation machines above a milk container. These milk containers are accessories for the coffee machine which stores milk for the preparation of mixed coffee-milk drinks such as cappuccino or the like. Typically, these milk containers are disposed beneath the coffee machine proper and have a milk-extraction tube that is connected to a suction pump of the coffee machine. Such milk containers are accessed through a thermally insulated housing and often have active refrigeration, either by means of a Peltier element or by way of another sufficiently well-known compression cooling. The milk remains in its packaging in this type of milk container. The milk-extraction tube is placed in the packaging and exits the housing through an opening. This type of milk container requires an electrical current supply. One advantage of this type of milk container is that a package of milk placed inside can be cooled down to a desired temperature.

To an increasing degree, fully automatic coffee machines are also used in homes. The purchase of an additional active milk refrigerator is frequently considered to be an unnecessary purchase in addition to problems of location and current consumption. However, the preparation of mixed coffee-milk drinks is desired by consumers. In such a case, a milk container can be used where the milk is poured into the container or the milk package sits underneath the coffee machine. However, in such an application the user occasionally finds out that the milk positioned underneath the coffee machine has gone sour, unbeknownst to him/her, and accordingly the mixed coffee-milk drink is bad. The passive milk storage-container known from patent DE 20 2008 016 202.5 is introduced to remedy this problem. Passive refrigeration is provided therewith by means of at least one cooling element previously refrigerated in an ice or freezer compartment. With this previously known milk storage-container, the milk itself is in its sales packaging, which is used as such in the thermally insulated, milk storage-container.

Such a milk container can be used, as is known from DE 20 2008 016 202.5, although not if the sales package cannot be used in the cooling chamber of the thermally insulated, milk storage-container. This is the case, for example, with packaging such that it does not fit in the cooling chamber due to its geometry or if its packaging is simply too large.

However, such a milk container cannot be used if the sales package cannot fit in the cooling chamber of the thermally insulated, milk storage-container for one reason or another. Either the packaging does not fit in the cooling chamber due to its geometry or the packaging can simply be too large.

The foregoing example of the related art and limitations related therewith are intended to be illustrative and not exclusive. Other limitations of the related art will become apparent to those of skill in the art upon a reading of the specification and a study of the drawings.

### SUMMARY

One aspect of the present disclosure is a storage container which is particularly suited for use as a thermally insulated, passively refrigerated, milk storage-container that is simple to operate.

Another aspect of the present disclosure is to provide a storage container with a storage insert functioning as the liquid container which has a top serving-opening for the removal of the liquid from the container. The serving opening is opened and closed by means of a pivotable carrying handle, the handle having a closure body for closing the serving opening. The handle and the closure body are positioned such that the closure body closes the serving opening when the handle is in a folded-down position relative to its carrying function.

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

The storage insert is a closed container, either inherently closed or using a removable lid closing the container on top, but which can be opened or removed. The container has a serving opening on top, to allow removing or extracting the liquid for the preparation from the container. In most uses, the container would be used to store milk. A suction tube for supplying the milk to the machine is inserted into the serving opening. The storage insert has a pivotable handle to allow of simple and secure handling of the insert. The handle allows the storage insert to be carried securely, for example from the refrigerator to a thermally insulated, milk storage-container disposed underneath a coffee machine, or back again. In addition, the handle of the container also bearers a closure body for closing the serving opening when the container is not in use. The serving opening is typically closed with the closure body when milk is stored in the container, for instance when the container is in the refrigerator. On the other hand, when the storage insert is in a thermally insulated milk storage-container, the closure body is outside the serving opening, allowing a suction tube to be inserted into it. The pivotability of the handle is used for the purpose of opening and closing the serving opening. Hence, the handle is articulated at the container and is pivotable in such a direction that it can, with its closure body, be swung in the direction of the serving opening in front or in back of it. The closure body itself is in such a position on the handle that upon swinging the same accordingly in the direction toward the serving opening, the closure body is brought up to the serving opening and it closes in the position with the handle lowered. The closure body is therefore disposed so it cannot fall off the container.

When the storage insert is in use in a thermally insulated, milk storage-container, the closure opening has to be open. Then the handle with its closure plug is in its other position, which does not close the serving opening. The period of time for carrying the container is brief and negligible. Hence, no problem is anticipated if the serving opening is not closed while the storage insert is carried. It is essential that the handle with its closure body be its closing position when the storage insert is placed with the contents in a refrigerator. The closing position is different than the carrying position of the handle. When the storage insert is in the refrigerator, the handle is not needed for its carrying function and is so is typically folded down to fit the storage insert into a refrigerator and, to be precise, in the position in which the closure body closes the serving opening. As a result, the contents of the storage insert are kept separated from the interior of the refrigerator. Therefore no odors or the like are absorbed by the liquid stored in the storage insert when the container is in the refrigerator.

With this storage insert, the closure body or a part of the handle covers the serving opening when it is closed. As a result, the position of the handle can act as an indicator to a user that the storage insert is securely closed when it is placed in a refrigerator.

According to one embodiment, the closure body is executed as a closure plug engaging the serving opening. Such a closure is preferably executed as a sealed closure. For this purpose the closure body can have an appropriate coating on the outside, for example a silicone coating, or the serving opening is edged with an insert made out of an elastic material in the serving opening Likewise, it is possible that the closure plug molded on the handle is made available in the passage area of the closure plug and the handle by a seal ring, which then lies on the upper edge of the serving opening to bring about the sealing. In the embodiment of a closure body as a closure plug, this preferably tapers conically in the direction away from the handle.

In this design at least one of the outer walls of the storage insert has at least one connecting member connected. As this part of storage insert is generally a plastic part, it is possible that the at least one connecting member is molded onto the container. This connecting member connects a passive cooling element and therefore contains a cooling element that is cooled in the ice compartment of a refrigerator or in a freezer compartment. By connecting such a cooling element to the storage insert, it is not only ensured that the cooling element is in the immediate vicinity of a wall of the storage container, but that it can also be moved together with the storage insert. If the storage insert with the connected cooling element is inside a thermally insulated, passive milk storage-container and is removed using the handle to set the container in the refrigerator when the drink-preparation machine is not in use, the cooling element is removed at the same time. In the refrigerator, the cooling element can be removed from the storage insert and placed in an ice compartment or in a freezer compartment. This means that when the storage insert and the cooling element are not in use, both parts can be set or placed in the appropriate refrigeration areas. Conversely, the same also applies when the storage insert with the milk is removed from the refrigerator and is placed into a thermally insulated, milk storage-container to be used with a coffee machine.

In an additional embodiment, the outer side of the storage insert has two connecting members with the connecting members spaced apart a given vertical distance from each other. In this embodiment, the upper connecting element is formed such that the cooling element can be hung on the upper connecting element. The lower connecting member is formed to allow the cooling element to rest on it. In an embodiment, the cooling element can be fitted tightly between the two connecting members such that it is connected to the container with no free play. This means that the cooling element does not wobble during transport of the storage insert, and is also always in its correct position adjacent to the container wall.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a perspective view of a thermally insulated, milk storage-container designed for placement underneath a drink preparation machine such as a coffee machine.

FIG. 2 is a perspective view in the milk storage-container of FIG. 1 with the cover opened.

FIG. 3 is a perspective view of a storage container disposed in the milk storage-container after removal of the same from the milk storage-container by means of its handle, in a first position.

FIG. 4 is a perspective view of a storage container disposed in the milk storage-container after removal of the same from the milk storage-container by means of its handle, in a further position.

FIG. 5 is a partial cross-sectional representation of the storage container of FIG. 3 through the serving opening of the container.

FIG. 6 is a representation corresponding to that of FIG. 5 with the handle in its position as shown in FIG. 4.

FIG. 7 is a perspective rear view of the storage container of the preceding figures.

FIG. 8 is the storage container of FIG. 7 with a passive cooling element connected thereto.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

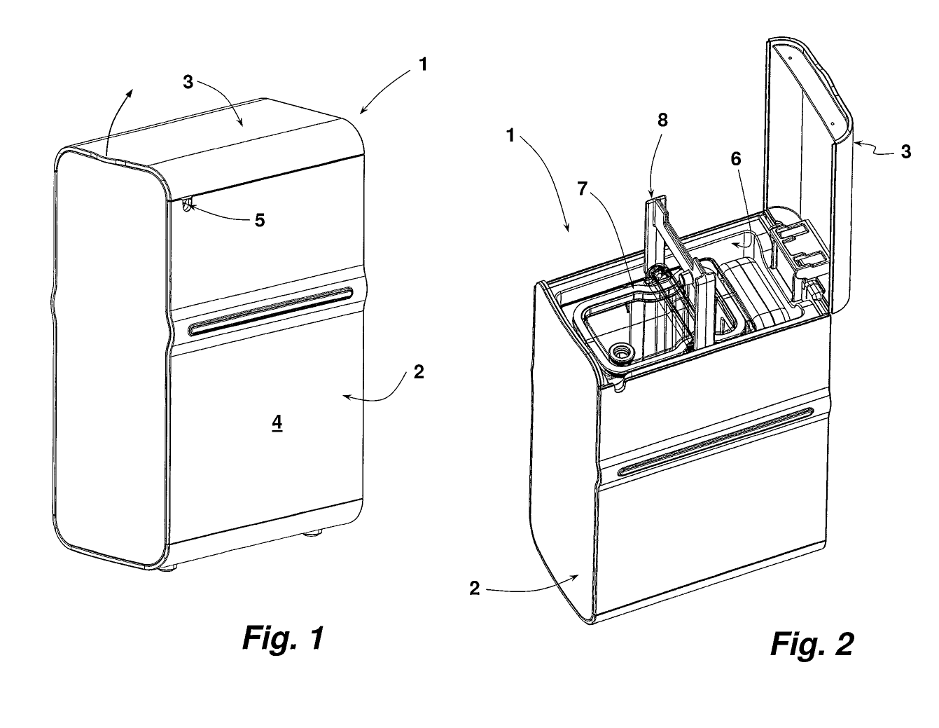

A milk storage-container 1, in a type and manner not depicted in detail, is attached to a fully automatic coffee machine. The milk storage-container 1 is formed as a plastic housing 2. The housing 2 has a pivotably attached a top cover 3. The pivoting movement to open the cover 3 is made in the direction of the arrow marked on FIGS. 1 and 2. A U-shaped opening 5 for a tube is introduced at the top of a side wall 4 of the housing 2. The tube opening 5 is bounded at the top by the lower edge of the cover 3. Tube opening 5 allows a milk-extraction tube to be set up with of its ends into a package of milk placed into the milk storage-container 1 and its other end attached to a suction pump of the drink preparation machine. Milk can be removed by means of the milk-extraction tube to prepare a milk or coffee-milk drink.

FIG. 2 shows the milk storage-container 1 with cover 2 opened. This view into the inside of the milk storage-container 1 shows that the housing 2 has thermal insulation 6 running around the inside. The base and the inside of the cover are also thermally insulated accordingly. Inside the milk storage-container 1 is a storage insert 7, in which the milk needed to prepare a drink is stored. A handle 8 is pivotably connected to the storage insert 7. FIG. 2 the handle 8 is shown in the position designed for removal of storage insert 7. Storage insert 7 can be either drawn out or inserted vertically from the interior framed by the thermal insulation 6.

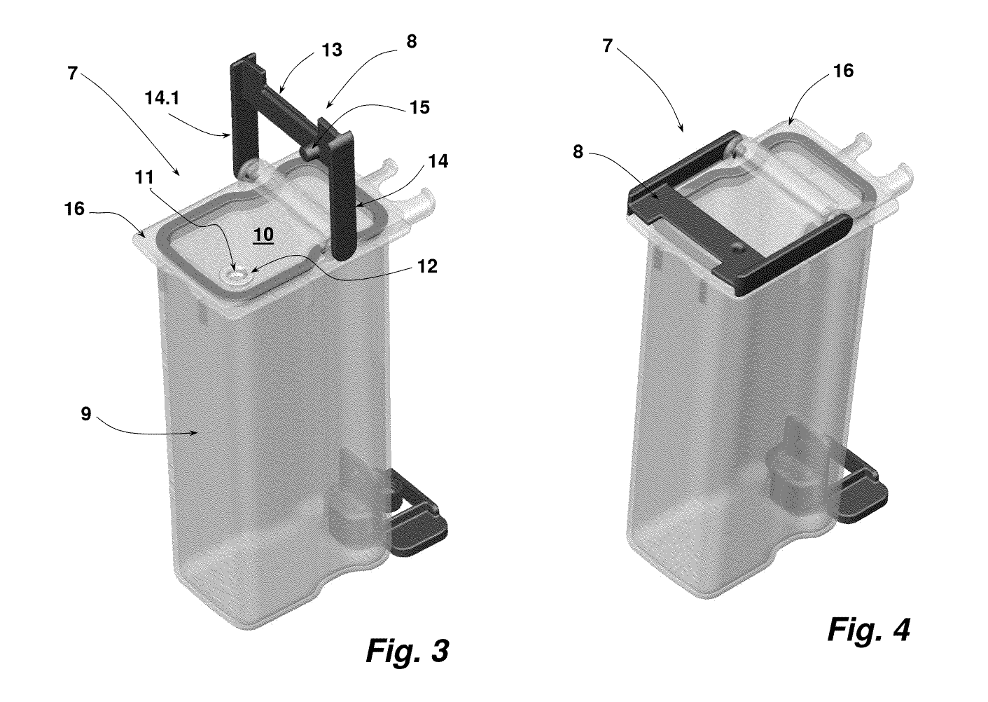

Storage insert 7 is illustrated by itself in FIG. 3. Container 7 of the depicted embodiment is formed as a container 9, which is closed with a cover 10. The cover 10 seals the upper opening of container 9 to close it. Cover 10 can be taken off to fill and/or clean the interior of container 9. Container 7 made up of container 9 and cover 10 is consequently operated closed. Inside cover 10 is a serving opening 11, which is bordered by a frame 12 made of elastic material, silicone for instance. The serving opening 11 allows a suction tube to pass inside the container 7 in order to be able to remove milk from container 7.

In an alternative embodiment, frame 12 of the serving opening itself has a molded piece of tube or piping, which reaches up to and into the area of the base of container 9. A suction tube for milk removal is then introduced, not necessarily to be inserted into the inside of the container, but it is connected to frame 12.

The handle 8 is pivotably connected to extensions of two opposing side walls of container 9. One pivot pin each side of the handle engages a bearing opening on the extension of container 9 for this purpose. Handle 8 is bow-shaped and includes a grip 13, which connects two legs 14, 14.1 to one another, on which in turn the pivot pins are formed. Formed on the grip 13 of handle 8 is a closure body executed as a plug 15. The plug 15 is tapered toward its free end and is disposed in such a position of grip 13 or of handle 8 that upon swinging handle 8 out of its position as shown in FIG. 3 into its position as shown in FIG. 4, plug 15 is inserted into frame 12 of the serving opening 11. Plug 15 seals the serving opening 11 upon its engagement with frame 12.

FIGS. 3 and 4 show that container 9 of container 7 has an encircling collar 16 on top. The collar 16 is executed so that it fits tightly to the thermal insulation 6 of the milk storage-container 1 if the storage insert 7 is inserted therein.

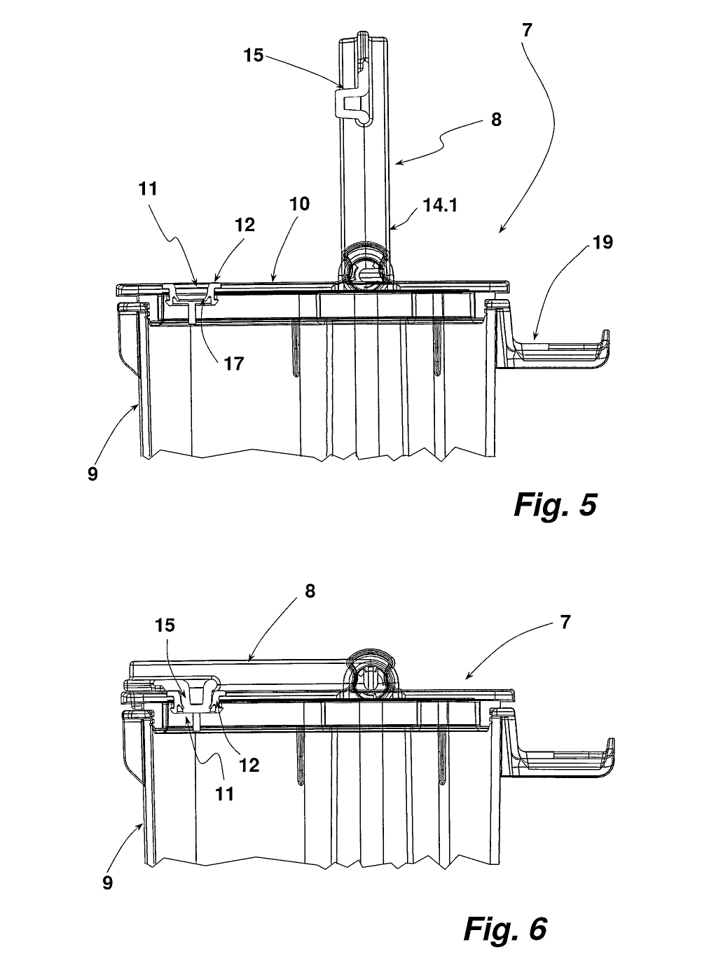

The cross-section of FIG. 5 clarifies the design of cover 10 regarding its engagement with container 9. The serving opening 11 with its frame 12, which is in the plane of the section, is depicted here. Frame 12 is made available for enclosure through a packing washer 17 projecting inward, which reaches to the sealed closure of the serving opening 11 on the outside of plug 15, as arises from FIG. 6, in which handle 8 with its plug 15 is disposed in its position closing the serving opening 11.

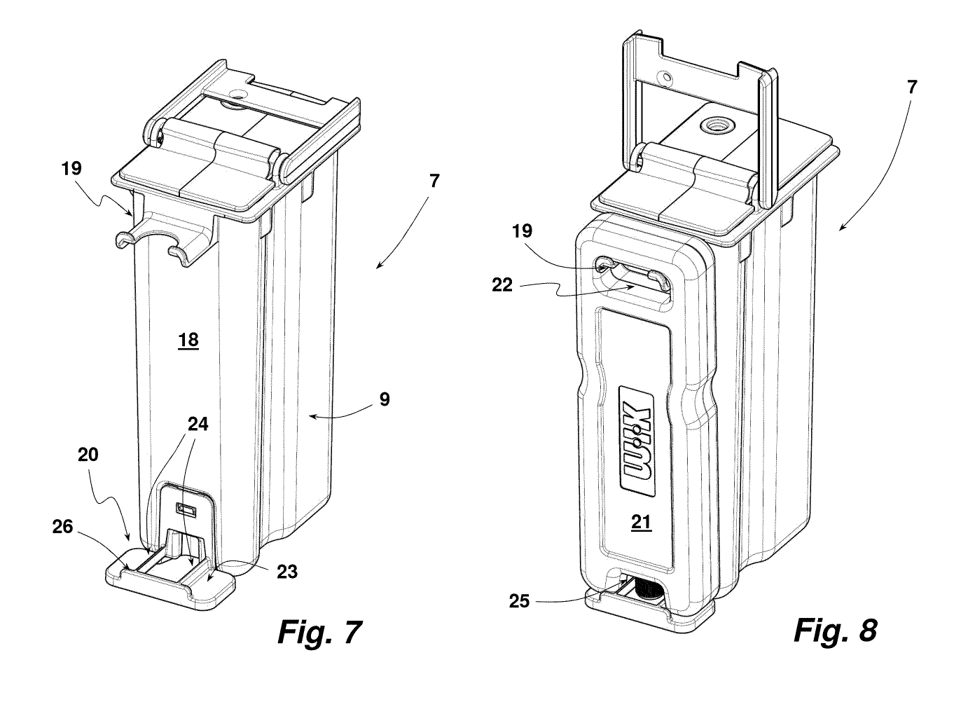

FIG. 7 shows the storage insert 7 in a rear view. The wall 18 of container 9, recognizable in FIG. 7, has a first connecting member 19 on top. This is executed as a type of hook. The first connecting member 19 is in the area of the upper end of container 9. A second connecting member 20 is connected to the lower end of container 9. Connecting members 19, 20 serve to introduce and hold a passive cooling element, as is shown with reference number 21 in FIG. 8. The cooling element 21 has an upper opening 22. With it, cooling element 20 is hung on the upper connecting member 19. The lower connecting member 20 serves to hold the cooling element 21 on the underside, which for this purpose stands with its underside on the base 23 of the second connecting member 20. In the depicted embodiment, the lower connecting member 20 is a separate component, which is connected to container 9 by means of a catch. Base 23 of the second connecting member 20 bears two positioning beads 24, which engage in between an underside recess 25 of cooling element 21. Base 23 of the second connecting member 20 also has a front flute 26, behind which stands the front side of cooling element 21. Consequently, a recess is formed by positioning beads 24 and flute 26 to hold the lower end of cooling element 21 in a form-fit manner in container 9 or container 7.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The above definitions are provided to clarify their specific use in the context of the invention.

### REFERENCE LIST

1 Milk storage-container
2 Housing
3 Cover
4 Side wall
5 Opening for tube
6 Thermal insulation
7 Storage insert
8 Handle
9 Container
10 Cover
11 Serving opening
12 Frame
13 Grip
14, 14.1 Leg
15 Plug
16 Collar
17 Packing washer
18 Wall
19 First connecting member
20 Second connecting member
21 Cooling element
22 Opening
23 Base
24 Positioning bead
25 Recess
26 Flute

I claim:

1. A container for storing a liquid food, in connection with supplying the liquid to a drink preparation machine, the container comprising:
the container having a top serving opening to allow the liquid food to be removed from the container for use in the drink preparation machine;
a handle pivotable connected the container for carrying the container;
said handle having a closure body for closing the serving opening; and
wherein the handle due to its pivotability on the container, and the closure body on the handle are disposed such that in a folded-down position of the handle when it is not in use, the serving opening is closed by the closure body.

2. The container of claim 1 wherein the closure body in its position closing the serving opening seals the serving opening.

3. The container of claim 1 wherein the closure body is a plug which engages it to close the serving opening.

4. The container of claim 1 wherein the container is closed on top by a cover having the serving opening and the cover is releasably connected to the container.

5. The container of claim 1 wherein the container is part of a thermally insulated, milk storage-container for a beverage preparation machine and the container has a package of milk inside, the milk package is made available through an opening for a milk removal tube to extend into the container to remove milk.

6. A container according to claim 5, wherein at least one compartment for receiving at least one passive cooling element is disposed in a receiving cooling chamber of the storage container separated by one of the containers, in which cooling-element compartment a cooling element is held that can be inserted and removed, and the cooling chamber for receiving the container containing milk is executed in such a way that, to achieve the same refrigeration of the milk contained in the container, it can be moved inside the cooling chamber some distance to the at least one cooling-element compartment and some distance to at least one of the side walls bounding the cooling chamber.

7. The container according to claim 5, wherein the container bears on at least one of its outer walls at least one connecting member for holding a passive cooling element.

8. The container according to claim 7, wherein the container further comprises two connecting members to hold a passive cooling element, a first connecting member is an upper connecting element formed as a hanger, on which a cooling element can be hung, and the second connecting member is a lower connecting member, on which an underside of the cooling rests when hung on the hanger on the upper connecting member.

9. The container according to claim 8, wherein the cooling element is held tightly fitting between the two connecting members of the storage insert.
